(19) United States
(12) Patent Application Publication
(10) Pub. No.: US 2025/0236068 A1
(43) Pub. Date: Jul. 24, 2025

(54) FIBER ALIGNMENT IN STEREOLITHOGRAPHY (SLA) 3D PRINTING OF COMPOSITE POLYMERS

(71) Applicant: George Mason University, Fairfax, VA (US)

(72) Inventors: Zahra Shaghayegh Bagheri, Bethesda, MD (US); Kunal Manoj Gide, Burke, VA (US)

(21) Appl. No.: 19/028,800

(22) Filed: Jan. 17, 2025

Related U.S. Application Data
(60) Provisional application No. 63/622,941, filed on Jan. 19, 2024.

(51) Int. Cl. B29C 64/165; B29C 64/264; B29C 64/314; B29K 105/14; B29K 105/18; B29K 505/08; B33Y 30/00; B33Y 40/10; B33Y 40/20; B33Y 70/10

(52) U.S. Cl. CPC B29C 64/165; B29C 64/264; B29C 64/314; B33Y 30/00; B33Y 40/10; B33Y 40/20; B33Y 70/10; B29C 2791/004; B29K 2105/14; B29K 2105/18; B29K 2505/08; B29K 2995/0008

(57) ABSTRACT

Additive manufacturing devices and methods enable the production of 3D-printed objects with varying strengths and characteristics based on the controlled orientation of filler materials. Magnetic fields applied during stereolithography (SLA) printing orient fillers within resin mixtures. This method, when compared to traditional 3D printing techniques, provides a more dynamic and adaptable approach to material design.

### CROSS-REFERENCE TO RELATED APPLICATIONS

This application claims the benefit of U.S. Provisional Patent App. No. 63/622,941, filed Jan. 19, 2024, the complete contents of which are herein incorporated by reference.

### FIELD OF THE INVENTION

Embodiments are directed to polymer composites and, more particularly, composites with embedded fillers and devices and methods for making the same.

### BACKGROUND

Additive manufacturing (AM) is a revolutionary process that fabricates objects by additively depositing material layers in a sequential manner, based on a computer aided design (CAD) models. AM encompasses many technologies such as but not limited to extrusion, powder binding, selective melting, and photopolymerization. Historically, AM has primarily been used for rapid prototyping (RP) due to its high iteration speed and versatility. However, there has been a significant shift towards incorporating additively manufactured parts into the end-use products, particularly in medical, automotive, dental, and aerospace sectors. For instance, in medicine and dentistry, AM's capacity to produce highly customized implants and prostheses using bio-compatible polymers has significantly impacted these industries. The aerospace and automotive sectors benefit from AM's capability to create structurally optimized, lightweight, and geometrically complex components—such as aerospace wings and fuselage sections-which enhances vehicle performance by increasing strength while reducing weight. These applications underscore AM's unique and valuable capabilities, establishing it as an essential manufacturing technology. AM's influence is expected to expand, with a projected economic impact of USD 550 billion by 2025. A major factor propelling this growth is the expanding use of AM in the production of final components. However, this rapid expansion has also accentuated challenges related to the mechanical, electrical, and thermal properties of traditional AM-fabricated polymers.

The increasing demand for load bearing, polymer-based additively manufactured parts has highlighted certain limitations particularly with regard to the mechanical strength of currently available materials. Although high-performance polymers, such as Polyether Ether Ketone (PEEK) are available, they are often challenging to process and may require expensive, specialized equipment to achieve optimal results. Other high-performance polymers, such as PPS (polyphenylene sulfide), PEK (polyether ketone), and PEKK (polyether ketone ketone), also present processing challenges but offer desirable properties, including mechanical strength, chemical resistance, wear resistance, and electrical conductivity. To mitigate processing challenges, material fillers are sometimes incorporated into the matrices of traditional, more easily processable polymers to enhance desired mechanical, electrical, and thermal properties.

The type of fillers incorporated into polymers can vary widely, as different fillers impart different properties into the composite. For instance, Romero-Ocana et al. used 5 wt. % of 45 μm or smaller particles of ground cork and found a 35% reduction in thermal conductivity of the resin (Form Clear v2, a mixture of photo initiator, acrylic monomers and oligomers) compared to the acrylic monomer and oligomers-based resin without ground cork filler (Romero-Ocaña, I., and Molina, S. I., 2022, “Cork Photocurable Resin Composite for Stereolithography (SLA): Influence of Cork Particle Size on Mechanical and Thermal Properties,” Additive Manufacturing, 51, p. 102586). Kalsoom et al. incorporated 30% w/v diamond particles as a filler material into a Miicraft cream resin in order to increase the thermal conductivity (Kalsoom, U., Peristyy, A., N. Nesterenko, P., and Paull, B., 2016, “A 3D Printable Diamond Polymer Composite: A Novel Material for Fabrication of Low Cost Thermally Conducting Devices,” RSC Advances, 6 (44), pp. 38140-38147. https://doi.org/10.1039/C6RA05261D). They found that the sample with 30% diamond fillers needed less than half the time to reach the target temperature of 60° C. from 20° C. compared to samples without diamond filler. Besides being used to affect a composite's thermal properties, fillers may be used to enhance mechanical properties of polymer composites. Sano et al. found that the tensile strength of continuous glass fiber filler in a cationic UV-cured epoxy resin increased from 10 MPa to 80 MPa, and Young's modulus increased from 125 GPa to 175 GPa as compared to pure epoxy resin (Sano, Y., Matsuzaki, R., Ueda, M., Todoroki, A., and Hirano, Y., 2018, “3D Printing of Discontinuous and Continuous Fibre Composites Using Stereolithography,” Additive Manufacturing, 24, pp. 521-527. https://doi.org/10.1016/j.addma.2018.10.033). While the above-identified studies demonstrated an improvement in mechanical or thermal properties by way of fillers in polymer composites, the type of filler is not the only factor that determines a material's final properties; the fabrication method can also have a major impact.

There are several AM techniques used to print composites, each with their own benefits and drawbacks. One widely used method is Fused Filament Fabrication (FFF), in which a thermoplastic polymer filament is heated, extruded through a nozzle, and deposited layer by layer. Despite their affordability and ease of use, FFF printers struggle to produce composites with high-quality surface finishes and adequate interlaminar strength. Moreover, the added time and labor required for the filament production further reduces efficiency, particularly for custom composites.

SLA (stereolithography) printing, which entails photopolymerization, is another method of AM. Stereolithography printing (SLA printing) represents a rapid prototyping technique in which UV light is directed onto a layer of photosensitive resin situated within a tank. Typically, one of three different UV light sources is employed: a DLP (digital light processing) projector, a laser specifically tuned to a designated wavelength, or LEDs. Both FFF and SLA build the model in layers, the data for which is typically taken from a CAD file. SLA has benefits over FFF such as higher speed, improved surface quality, and higher resolution. These advantages can be attributed to SLA's distinctive process, in which a liquid photopolymer resin in cured on the build plate using a light source such as a UV laser or projector. Although it is possible to arrange fillers via FFF printing, the process is more time-consuming as the filament must be manufactured separately.

Despite their success, current SLA 3D printers available in the market are marked by inherent limitations, specifically anisotropic mechanical properties arising from its layer-wise construction, resulting in compromised structural integrity and mechanical strength, particularly in intricate geometries. Despite the numerous benefits of SLA 3D printed polymeric parts, their applications are still very limited due to the lack of mechanical properties. Also, notable constraint in commercially available SLA printers lies in their incapacity to produce composites with regulated fiber orientation.

### SUMMARY

An aspect of some exemplary embodiments is modifications to and improvements in stereolithography (SLA) 3D printers which provide the precise control of filler material orientation in composite structures. Stereolithography (SLA), an AM technique employing a focused ultraviolet (UV) light beam for curing a photopolymer resin, boasts a significant edge over alternative methods. Its remarkably high resolution, achieved by printing thin layers, facilitates the meticulous reproduction of intricate details within the object. A significant difference between a UV SLA printer and a digital light processing (DLP) printer is that in a UV SLA printer, such as those of the present disclosure, a single light beam (e.g., laser beam) is rastered across the printed layer whereas in a DLP printer the cross-sectional area of the layer is printed as one.

A particular advantage of photopolymerization techniques of this disclosure is the capability to precisely arrange fillers during the printing process. An aspect of some exemplary embodiments involves electromagnetic field induced fiber alignment. Exemplary methods utilize a selection of one or more polymers compatible with SLA 3D printing technology. To achieve particular material properties, at least one liquid resin may be combined with one or more metal fibers, one or more non-metallic fibers coated with metal, or both metal fibers and non-metallic fibers coated with metal. Different embodiments are disclosed offering various integrations of magnets (e.g., electromagnets) into SLA printers. The electromagnets may be polarized in a specific predetermined sequence during the printing process. The targeted electromagnets interact exclusively, in a variety of configurations, with magnetizable filler fibers present in the resin vat. Before each layer is cured, the orientation of the filler (e.g., filler fibers) is dynamically adjusted by the magnetic field, enabling the creation of composite materials with tailored properties. Exemplary embodiments align fillers strategically to exploit their reinforcing potential while maintaining the integrity of the polymer matrix in which the filler is embedded.

An exemplary electromagnetic filler alignment system in an SLA 3D printer comprises electromagnets positioned at a variety of locations within the printing chamber to facilitate real-time manipulation of reinforcing fibers within the liquid resin, ensuring a controlled and uniform alignment throughout the printing process, thus addressing challenges associated with misalignment. The electromagnets manipulate filler (e.g., reinforcing filler) magnetically in real-time during the printing process. The electromagnetically aligned fiber-reinforced composites produced by such an exemplary SLA 3D printer demonstrate desirable mechanical properties.

An electromagnetically controlled orientation mechanism allows for layer-by-layer customization of filler orientation, resulting in composite objects with unique and tunable material properties. Accurate control over fiber orientation allows for tuning of properties and is significant in applications of composite materials in industries such as but not limited to aerospace/aviation, medicine, thermal, computing, transportation, electrical, and consumer goods. The innovative application of electromagnetic control in the SLA 3D printing process introduces new possibilities for creating objects with particular requirements for one or more of strength, resilience, flexibility, thermal conductivity, electrical conductivity, and complex geometries not possible with known 3D resin printing techniques. Exemplary embodiments allow for custom 3D parts to be made which have particular mechanical, thermal, and/or electrical properties.

An exemplary method of additive manufacturing comprises combining in a vat at least one liquid resin and one or more fillers, wherein at least one filler of the one or more fillers is magnetically orientable; manipulating orientation of the at least one filler with a magnetic field; and rastering a UV light beam across a print area, wherein the UV laser beam cures the at least one liquid resin as a matrix that holds the at least one filler in the orientation caused by the magnetic field. An exemplary composite is a composite produced by such an exemplary method.

An exemplary additive manufacturing (AM) apparatus comprises a vat for holding a combination of at least one liquid resin and one or more fillers, wherein at least one filler of the one or more fillers is magnetically orientable; a filler alignment system configured for manipulating orientation of the at least one filler with a magnetic field; a laser or LED configured to emit a UV light beam with at least one designated wavelength suited for curing the at least one liquid resin, wherein the UV light beam is rasterable across a print area, wherein the UV light beam cures the at least one liquid resin as a matrix that holds the at least one filler in the orientation caused by the magnetic field; and a build plate to which the matrix is attached.

A feature of some alternative embodiments involves alternative configurations of electromagnet integration with other components of the SLA printer. An aspect of some exemplary embodiments is a means for changing arrangement of one or more magnets and the build plate of the SLA printer. An aspect of some exemplary embodiments is a rotating mechanism with one or more electromagnets moveable with respect to the resin vat and/or a build plate moveable with respect to the one or more electromagnets. Specifically, in one exemplary embodiment, a rotating mechanism is introduced to electromagnets to enhance control over fiber orientation, thereby extending beyond the capabilities of fixed magnet positions offering limited orientations such as zero (0) and 90-degree orientations.

### BRIEF DESCRIPTION OF THE DRAWINGS

FIG. 1A is a flowchart of an exemplary method of additive manufacturing (AM);

FIG. 1B is a diagram of layer-by-layer manufacture by stereolithography (SLA) 3D printing;

FIG. 2A is a perspective view of an exemplary SLA 3D printer;

FIG. 2B is a top view of the SLA 3D printer of FIG. 2A;

FIG. 3A is a perspective view of another exemplary SLA 3D printer;

FIG. 3B is a top view of the SLA 3D printer of FIG. 3A;

FIG. 4 is a pair of exemplary electromagnets;

FIG. 5 is an exemplary resin vat;

FIG. 6 is yet another exemplary SLA 3D printer;

FIG. 7A is an optical microscopy image of a 3D object consisting of pure resin;

FIG. 7B is an optical microscopy image of a 3D object consisting of cured resin with embedded cobalt filler of random orientation;

FIG. 7C is an optical microscopy image of a 3D object consisting of cured resin with embedded cobalt filler having 0 degree alignment;

FIG. 7D is an optical microscopy image of a 3D object consisting of cured resin with embedded cobalt filler having 90 degree alignment;

FIG. 8A is a bar chart representing modulus of elasticity for material samples discussed in the Example;

FIG. 8B is a bar chart representing yield strength for material samples discussed in the Example;

FIG. 8C is a bar chart representing ultimate tensile stress for material samples discussed in the Example.

### DETAILED DESCRIPTION

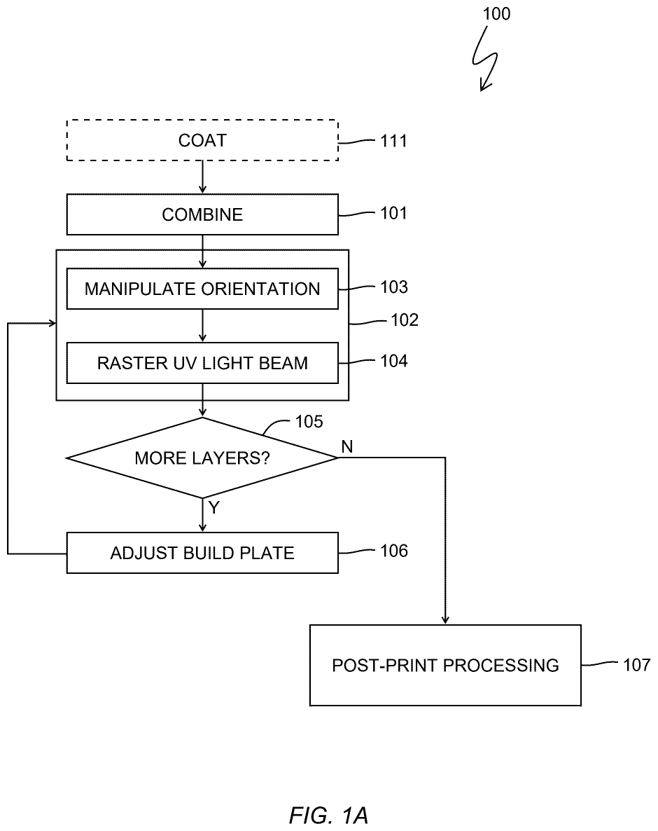

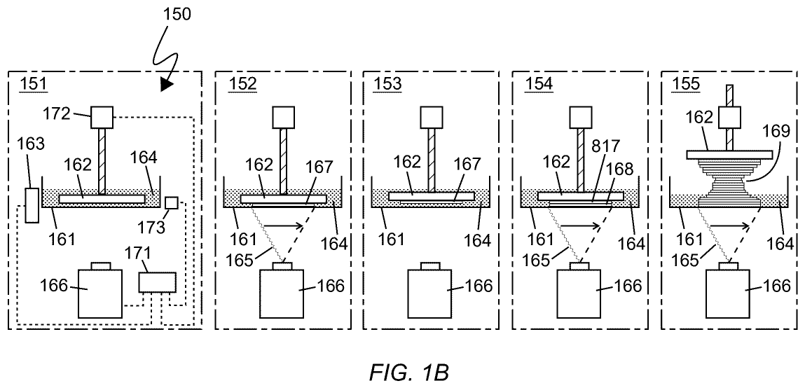

FIG. 1A is a flowchart of an exemplary method 100 of additive manufacturing. The method 100 involves electromagnetic field induced fiber alignment during stereolithography (SLA) printing with a rastered light source, e.g., a UV laser or UV LED. Block 101 comprises combining at least one liquid resin and one or more fillers. The at least one resin is, for example, an uncrosslinked but crosslinkable polymer (e.g., a photocurable polymer). At least one filler of the one or more fillers is magnetically orientable. The units of the at least one filler are configured to react to magnetic forces. Block 103 comprises manipulating orientation of the at least one filler with a magnetic field. The singular use of “magnetic field” in this disclosure is meant as “at least one” magnetic field, which may be a single magnetic field or multiple coincident magnetic fields which may each be from a different source, for example. In this disclosure manipulation of filler “orientation” may be interchangeably referred to as manipulation of filler “alignment”. Orientation/alignment may be characterized relative to any of a variety of comparative elements. For instance, orientation/alignment of filler elements may be characterized relative to other filler elements. As an example, thousands of fibers may be aligned with one another so that a majority up to substantially all fibers are aligned with one another in a common direction of a reference frame (such as but not limited to a 3D coordinate system such as X, Y, Z coordinates). Orientation/alignment may also or instead may be expressed relative to one or more of the following: Earth's gravity vector, magnetic field lines, one or more magnets, a build plate, and a resin vat, or any part thereof.

Block 104 comprises rastering (e.g., moving along a path or pattern of lines) a UV light beam across a print area. A print area is generally characterized by at least two dimensions, e.g., non-zero X and Y dimensions. The effect of the rastering step 104, which exposes the combination mixture from block 101 that is within the print area to UV energy, is to “print” a layer of solid or at least semi-solid material. The resin in the printed layer is at least partially cured by the UV energy. In particular, the UV beam cures the at least one liquid resin as a matrix that holds the at least one filler in the orientation caused by the magnetic field. Even after the magnetic field is removed, the alignment of the filler units in the cured resin remains fixed relative to other filler units in the cured layer and relative to the matrix.

While a single print object may consist of a single print layer, it is desirable for most objects to print a plurality of layers which collectively form the print object. Block 105 queries whether further layers remain to be printed. If at least one layer remains, the SLA printer build plate is adjusted at block 106. A typical adjustment at block 106 is adjusting the relative spacing of the build plate and the resin vat. This may entail moving one or both of the build plate and resin vat relative to the other. For instance, the build plate may be raised relative to the floor of the resin vat. Then the process 100 returns to the general print block 102. For some layers, the magnetic field orientation may or may not be manipulated, depending on the desired properties of the final printed object. However, in general, block 102 includes at least rastering step 104. For many objects, printing each of a plurality of layers involves both manipulating orientation of at least one filler with a magnetic field and rastering a UV light beam over the print area while the magnetic field holds the desired orientation of the at least one filler. In such a case the method 100 comprises repeating the manipulating and rastering steps for multiple successive layers with layer-by-layer customization of filler orientation. It should be appreciated that some layers may match one another with regard to the orientation of their respective filler contents. Depending on the desired properties of the print object, the orientation of the applied magnetic field may be changed for printing one layer versus printing another layer, or the orientation of the applied magnetic field may be the same for printing multiple layers. In some implementations, block 103 may include changing properties of the applied magnetic field other than or additional to magnetic field orientation. For instance, block 103 may include changing one or more of magnetic flux and magnetic field strength.

Block 107 entails any post-print processing steps which may or may not be included depending on the implementation and particular needs of a particular practical application. As a non-limiting example, block 107 may comprise, after all occurrences of printing block 102 are finished, washing the multilayer print object (e.g., in an isopropyl alcohol (IPA) bath) and/or further curing the fully printed object under an ultraviolet (UV) light. Such exemplary post-print processing steps respectively ensure excess liquid resin is removed and that the sample is fully cured before being put to its intended use. Other post-print processing steps which may be employed depending on the embodiment include but are not limited to removal of remaining supports if the print required the inclusion of temporary supports and changing the surface texture of the printed object, e.g., sanding the fully cured object for achieving a smoother finish and to minimize surface defects.

Block 101 entails combining photopolymerizable polymers with other materials to achieve enhanced properties over pure polymer. Such combinations are known as composite materials, which consist of at least two phases (matrix and at least one filler) with different physical or chemical properties. Generally, the combination is mixed thoroughly, e.g., until the mixture is substantially homogeneous. Mixing may be performed with one or more stirrers such as but not limited to a magnetic stirrer, for example. Ratios of fiber-to-resin may vary among embodiments depending on the intended use/application of the part to be printed. As a non-limiting example, a mixture may have a up to an 8% (e.g., a 1%) by-volume filler-to-resin mixture. As a further non-limiting example, filler may constitute about 1 vol % to about 32 vol % of the components used in the production of an exemplary composite. In certain embodiments, the filler may be about 1 vol % to about 10 vol % of the components used in the production of the composite. In certain embodiments, the fibers are about 1 vol % to about 8 vol % of the components used in the production of the composite.

Embodiments may employ any of a variety of UV-curable polymer resins which may include commercially available and/or proprietary resins. A variety of UV-curable polymer resins are commercially available for SLA printing, any one or more of which may be employed in embodiments in accordance with this disclosure. As one non-limiting example, a liquid resin usable with method 100 of FIG. 1A is eSUN's “hard-tough” resin, which offers properties similar to acrylonitrile butadiene styrene (ABS) once cured.

Fillers may range from nano to macro-sized and are typically solid. Exemplary fillers may be characterized as being one or more of particles, particulates, powder, filings, fibers, filaments, and 2D materials. In this disclosure, a filler is not simply another polymer resin. Rather, a filler is a plurality of like objects/units which are embedded in the cured polymer matrix after printing is complete. Depending on the application, different types and distributions of filler materials in the matrix can produce various mechanical, electrical, and/or thermal properties of resultant composite parts. In some embodiments, fillers may include soft fibers and/or hard fibers. Soft fibers for use in various embodiments of this disclosure include but are not limited to synthetic polymer fibers, such as poly (p-phenylene-2,6-benzobisoxazole) (PBO) fibers; aromatic polyamide fibers including but not limited to poly-p-phenylene terephthalamide fibers and poly-m-phenyleneisophthalamide fibers; polyphenylene sulfide fibers; polyurethane fibers; and nylon or ultra-high molecular weight extended chain polyethylene (UHMPE). In certain embodiments, the soft fibers include at least PBO fibers. Commercially available PBO fibers include but are not limited to Zylon™ (Toyobo Co., Japan). Hard fibers for use in various embodiments of this disclosure include but are not limited to synthetic inorganic fibers such as carbon fibers, glass fibers, asphalt fibers, graphite fibers, basalt fibers, and silicon carbide (SiC). In certain embodiments, the hard fibers include at least carbon fibers. Commercially available carbon fibers include but are not limited to Zoltek™ PX35. In certain embodiments, filler fibers for use in methods of the present disclosure have a diameter of about 10 μm to about 100 μm. In certain embodiments, the lengths of the fibers for use in the methods of the disclosure are about 1 mm to about 50 mm. A worker skilled in the art will appreciate that the fibers may be broken into smaller pieces when mixed e.g. in a compounder.

Different embodiments may utilize different types of fillers. The at least one filler used in block 101 which is magnetically orientable may be, for example, metallic or a non-metallic material coated with one or more metals. Some combinations may include both metallic filler and metal-coated non-metallic filler. The filler may also be a fiber filler such that the at least one filler comprises metal fibers and/or non-metallic fibers coated with at least one metal. Exemplary metals include but are not limited to iron, nickel, and cobalt. In some embodiments cobalt is preferrable over iron and nickel because cobalt fibers align more easily with a given magnetic field than metallic fibers such as iron fibers or nickel fibers. Cobalt has a higher magnetic anisotropy. Cobalt fibers have excellent magnetic as well as tensile properties (e.g., exemplary cobalt fibers have a tensile strength range of 625-1250 MPa). An exemplary but non-limiting example filler is cobalt particles of e.g. 300 mesh size.

In embodiments in which at least one filler comprises metal coating, method 100 of FIG. 1A may include coating step 111. An exemplary coating process involves applying a thin layer of metal onto the surface of non-metallic fibers, enhancing their conductivity which in turn improves the ability to orient the fibers using a magnetic field while using an exemplary SLA 3D printer. Coating may be a partial coating or a complete coating. One exemplary method of applying a coating is through sputtering. A sputtering process may be configured to ensure uniform coverage and compatibility of non-metallic fibers with magnetic SLA 3D printing.

FIG. 1B is a diagram of an exemplary SLA printing apparatus 150 depicted at various stages of production. The apparatus 150 is configured to perform exemplary methods like method 100 of FIG. 1A.

At stage 151 a vat 161 is filled with a viscous mixture 164 that comprises metallic or metallic-coated filler units (e.g., fibers) and one or more polymers including at least one photocurable polymer. The mixture 164 may contain additional materials such as but not limited to one or more 2D materials. Filler volume percentage in the formulation is determined at least in part by a minimum viscosity required for successful SLA printing. For instance, the filler volume percentage may be less than 8%, less than 7%, less than 6%, less than 5%, less than 4%, e.g. 3%. A “vat” in this disclosure may be interchangeably referred to as a tray, container, or tank. A build plate 162 is positioned to be in contact with the viscous mixture 164. A magnetic force is applied, e.g., by an electromagnet 163, to manipulate filler orientation in the viscous mixture. While the fibers are aligned with the magnetic field and therefore substantially aligned with one another, a single layer 167 of the viscous mixture is cured at stage 152 by light beam 165 from radiation source 166 (e.g., a UV laser or UV LED(s)). The light beam 165 is rastered across the print area, as indicated by the arrow indicating the beam 165 traveling left to right in the figure. In reality, the light beam 165 is moved in at least two dimensions, e.g., both an X direction and Y direction, which may correspond with left-right in FIG. 1B and into-the-page-out-of-page in FIG. 1B, respectively. At stage 153 the build plate 162 is moved relative to the vat 161 (or the vat may be moved relative to the build plate) so that the previously cured layer is exposed to further uncured material 164. At stage 154 another layer 168 is cured. The raster path and/or timed pulses of the light beam 165 may vary from one layer to the next according to the shape of the 3D object to be printed. Stage 155 shows the progress of 3D printing the object 169 after several further layers have been printed.

The exemplary process illustrated by stages 151-155 of FIG. 1B involves a reverse/“bottom-up” printing position. The object 169 is generated on a platform 162 immersed in the resin mixture 164, gradually ascending with each layer's thickness. Distinct “base layers” including at least first layer 167 may undergo longer UV exposure than subsequent layers to ensure the creation of a more robust foundation which firmly adheres to the build plate 162. Following the polymerization of each printed layer, the printed layer may adhere to the bottom of the vat 164, in which case the AM process may include detachment after the completion of each layer-building iteration. This sequential process is reiterated until the finalization of the entire printed piece 169. In alternate embodiments, a printer 150 may be configured with the opposite printing direction than what is depicted in FIG. 1B. That is to say, the build plate may descend (rather than ascend) after each layer. The relative position of the other components such as the light source 166 are adjusted accordingly.

One of two different UV light sources may be employed for curing the resin: at least one laser or at least one LED specifically tuned to a designated wavelength or band. The radiation source 166 is configured to supply a focused UV light beam, emitted by a laser or a high-intensity LED operating at a wavelength of, e.g., 405 nm, directed onto a layer of photosensitive resin mixture 164 situated within a transparent-bottomed tank 161.

An exemplary additive manufacturing process may be controlled by one or more processors 171 which may include or be part of a controller, computer, server, or the like. The one or more processors 171 may be configured to control one or more (up to all) of light source 166, electromagnet 163, build plate positioning device 172, and one or more sensors 173. FIG. 1B includes dotted lines representing connection of the one or more processors 171 with the foregoing subparts of the AM printer 150 by wired and/or wireless connections. The electromagnet 163 and one or more processors 171 configured for controlling the electromagnet 163 together may be characterized as belonging to a filler alignment system. The filler alignment system may further comprise the sensor 173.

It should be understood that block 163 in FIG. 1B is representative of one or more electromagnets 163. The block 173 is representative of one or more sensors 173. Owing to limited space and for simplicity of illustration, FIG. 1B omits illustration of elements 163, 171, and 173 in stages 152-155, but it should be understood these elements would remain configured substantially the same as depicted in stage 151.

It is advantageous in some embodiments that the solenoid center of electromagnet 163 align with the plane of the print area. In FIG. 1B, the print area is the space between the build plate 162 and the bottom of the vat 161. For alignment of the solenoid center with the print area, the solenoid may be arranged (e.g., hung) such that part of the solenoid extends below the bottom of the vat 161, as depicted at stage 151.

The exemplary printer 150 comprises at least one sensor 173 to achieve layer-by-layer printing with a high degree of precision and accuracy. Acknowledging the importance of accuracy in the printing process, an exemplary sensor 173 may be configured to read each layer's changes as the build plate 162 ascends. The one or more processors 171 are configured to adjust the print process based on readings from the sensor 173. For example, the one or more processors 171 may be configured to dynamically adjust the voltage transmitted to the solenoids 163, thereby influencing the orientation of the magnetic filler fibers within the vat 161. More than one sensor 173 may be used for alternative embodiments of magnetic filler orientations.

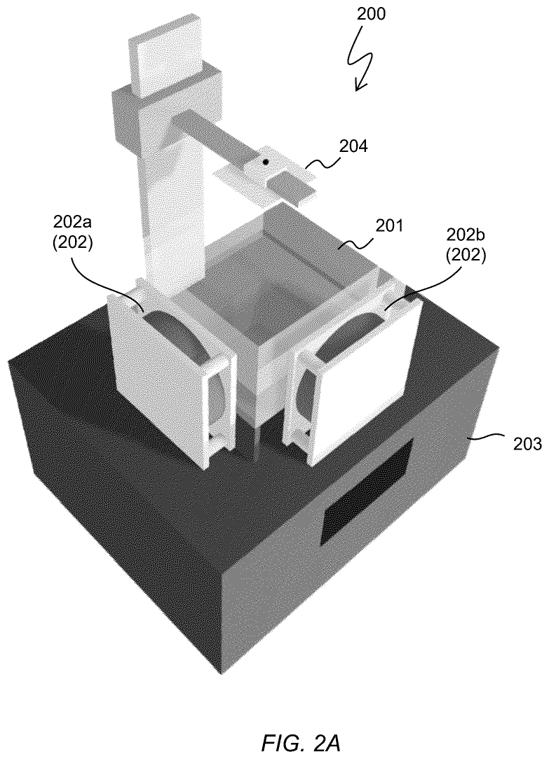

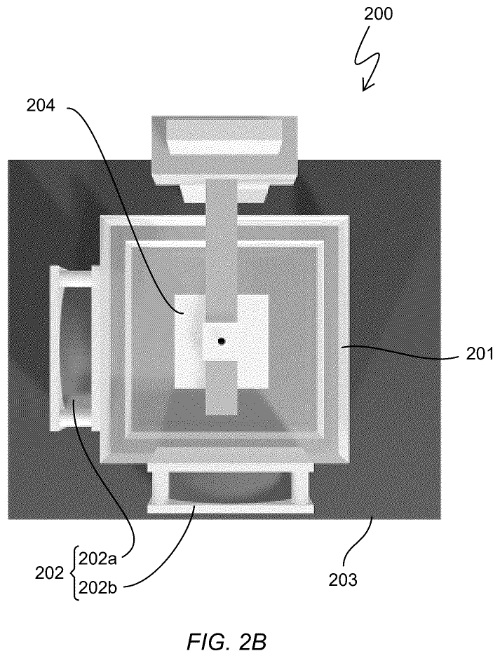

FIGS. 2A and 2B are views of a further exemplary AM apparatus 200, in particular an SLA (3D) printer. The SLA printer 200 comprises a vat 201, a filler alignment system 202 that includes electromagnets 202a and 202b, a laser or LED(s) within a housing 203, and a build plate 204. Vat 201 is configured for holding a combination of at least one liquid resin and one or more fillers. At least one filler of the one or more fillers is magnetically orientable. Filler alignment system 202 is configured for manipulating orientation of the at least one filler with a magnetic field. The exemplary filler alignment system 202 is electromagnetic; the system 202 comprises electromagnets 202a and 202b. The laser or LED within housing 203 is configured to emit a UV light beam with at least one designated wavelength suited for curing the at least one liquid resin. The UV light beam is rasterable across a print area to cure the at least one liquid resin as a matrix that holds the at least one filler in the orientation caused by the magnetic field. The matrix is attached to the build plate 204 during manufacture. The SLA printer 200 may be configured and operated consistent with the illustrations and descriptions above of FIGS. 1A and 1B.

FIGS. 2A and 2B show a non-limiting but exemplary arrangement of a plurality of electromagnets 202a, 202b positioned about the vat 201. The electromagnets 202a, 202b have different fixed positions relative to the vat 201. The filler alignment system 202 is configured to change the orientation of the magnetic field inside the vat 201 by deactivating one or more of the plurality of electromagnets and/or activating one or more of the plurality of electromagnets. The control of activation and deactivation of different ones of the plurality of electromagnets may be by one or more processors (not shown in FIGS. 2A and 2B; see schematic illustration of FIG. 1B which includes one or more processors 171).

Exemplary embodiments may utilize a variety of electromagnet configurations to precisely align filler fibers within different polymer composites through SLA 3D printing. Advantages of exemplary embodiments include enhancing properties necessary for specific applications during the production of critical components for the transportation, aerospace, and medical sectors, among others. Control over the orientation of composite fibers during the printing process provides the fabrication of sturdier, more dependable parts, thereby reducing failure rates and augmenting consumer safety.

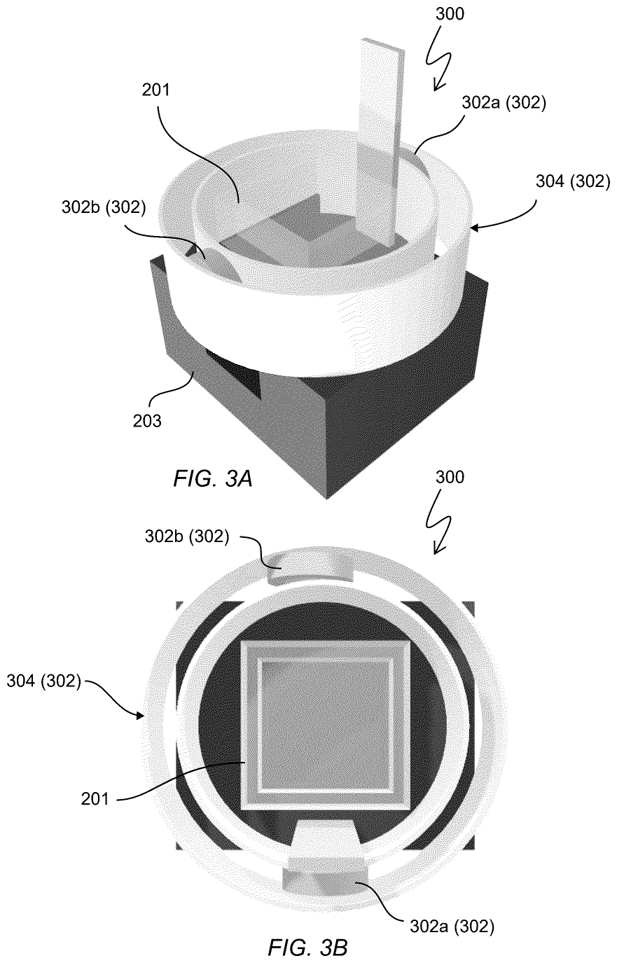

FIGS. 3A and 3B are views of a further exemplary AM apparatus 300, in particular an SLA (3D) printer. The SLA printer 300 comprises a vat 201, a filler alignment system 302 that includes electromagnets 302a and 302b, a laser or LED(s) within housing 203, and a build plate (not shown; see, e.g., build plate 204 of FIGS. 2A/2B). The filler alignment system 302 comprises at least two magnets 302a and 302b positioned at opposite sides of the vat. It is advantageous for the magnets 302a and 302b be configured so that the south pole of one of the magnets faces the vat 201 while the north pole of the other of the magnets faces the vat 201. Arranged across from one another, the north pole of one of the magnets faces the south pole of the other of the magnets. The poles may be oriented thus according to the winding directions of the wire coil of each respective magnet and/or the direction of applied current through the windings, in the exemplary case that the magnets are both electromagnets. The configuration of a pair of magnets with opposite poles facing one another from across opposite sides of the vat is advantageous for creating especially linear and parallel magnetic field lines between the pair of magnets and thus through the vat 201 and resin mixture contents in the vat 201. The size of the magnets 302a/302b and/or the currents supplied to the magnets 302a/302b may also be reduced compared to the size/current required of a single magnet like magnet 202b of SLA printer 200 while offering as good or better magnetic field lines in terms of how close to true linear and parallel the magnetic field lines are inside the vat 201.

A limitation of fixed position magnets in some apparatuses is a finite number of specific filler orientations. To overcome this limitation, a further aspect which may be included in an exemplary AM apparatus like SLA printer 300 is configuration of the filler alignment system 302 to include a rotating mechanism 304. In this case the filler alignment system 302, in particular the rotating mechanism 304 thereof, is motorized and configured to change the orientation of the magnetic field in the vat 201 by moving (in particular, rotating) one or more of the magnets 302a/302b relative to the build plate and/or moving the build plate relative to the one or more magnets 302/302b supplying the magnetic field. According to the exemplary SLA printer 300, the magnets 302a/302b are moveable relative to both the build plate and the vat 201. Whatever the frame of reference, the magnets are changing positions relative to the object being printed during and/or between printing of individual layers of the object.

The rotating mechanism 304 may be positioned about (e.g., surrounding) the resin vat 201, and hold or house electromagnets 302a and 302b. The electromagnets may be any number and type of shape, including round, oval, rectangular, and square, among others. Other rotating mechanisms and electromagnets may combine in a variety of configurations to provide fiber orientations for each intended application and product. These dynamic configurations allow for a greater number of achievable fiber orientations than printers which have only a few magnets all with fixed positions relative to the resin vat.

An exemplary operational sequence involves actuating the rotation mechanism 304 to rotate before each layer is printed for which a change in magnetic field orientation is needed compared to the preceding layer, dynamically aligning the filler fibers with the resin vat to the desired orientation. Once the layer printing commences, the orientation may be fixed, ensuring precision and uniformity within the layer. Subsequently, as the build plate ascends post-layer completion, the electromagnets' housing mechanism seamlessly rotates to the next predetermined position for the subsequent layer. This systematic approach not only enhances the SLA 3D printer's versatility but also provides a controlled method for achieving complex and tailored material properties.

In addition, or in the alternative, to fixing magnet positions and/or activation/deactivation statutes of electromagnets for the entirety of time the UV light beam is rastering a single layer, an exemplary filler alignment system may change the orientation of the magnetic field while the UV laser beam is rastered (midprint) of a single layer if the ultimate use of the object makes it desirable for filler orientation to differ within different regions of a single print layer.

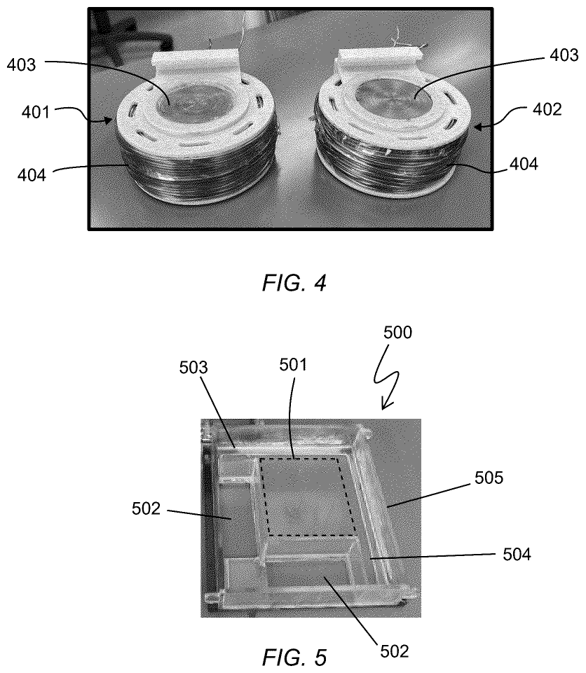

FIG. 4 shows a pair of exemplary electromagnets 401 and 402. Each electromagnet 401 and 402 is a solenoid with a conductive core 403 and wire windings 404. The number of wire loops may vary among embodiments but a non-limiting example is approximately 220 loops. A solid conductive metal core 403 may be substituted in some embodiments with an air core. However, a solid core permits a size reduction in the solenoid relative to an air core, and thus a solid core is preferable where space constraints are present. A core-based solenoid has the advantage of a reduced size relative to an air code solenoid capable of producing a like-sized magnetic field.

Exemplary resin vats may vary among embodiments. Exemplary vat 201 of FIGS. 2A-2B and 3A-3B presents the non-limiting but exemplary vat configuration of a lidless rectangular prism. The shape and size of the vat is more consequential in AM apparatuses which include means of magnetically orienting fillers, however, compared to apparatuses which have no such means of orienting fillers. In general, the larger the vat, the greater the distance between magnets positioned around the vat and the vat's center. Challenges include limited reach of the magnetic field and magnetic fields lines undesirably changing direction to too great an extent within the print area of the vat. Placing magnets externally (i.e., outside the vat) may necessitate disproportionately large solenoids for the magnetic field to effectively reach the vat's center. One solution to this problem is the use of paired magnets on opposite sides of the vat, as illustrated with apparatus 300 of FIGS. 3A and 3B. Another solution which may be employed in some embodiments is the inclusion of unconventional vat configurations.

FIG. 5 presents a resin vat 500 configured to permit electromagnet placement within the resin vat, which is to say the electromagnets are positioned so that resin-holding portions of the vat exist on multiple sides of the electromagnets. The vat 500 has a print area 501 with electromagnet receiving spaces 502 to sides of the print area 501. The vat has a resin-holding area larger than the print area 501. In particular, the resin-holding area includes not only print area 501 but also vat portions 503 and 504 which are positioned to sides of the electromagnet receiving spaces 502. A rectangular border 505 bounds all the spaces 501, 502, 503, and 504. Areas 503 and 504, though not part of the print area 501, serve as resin reservoirs. The vat 500 is designed to accommodate the build plate's descent, providing ample space for resin expansion without any risk of leakage. The build plate is configured to align with the vat's print area 501.

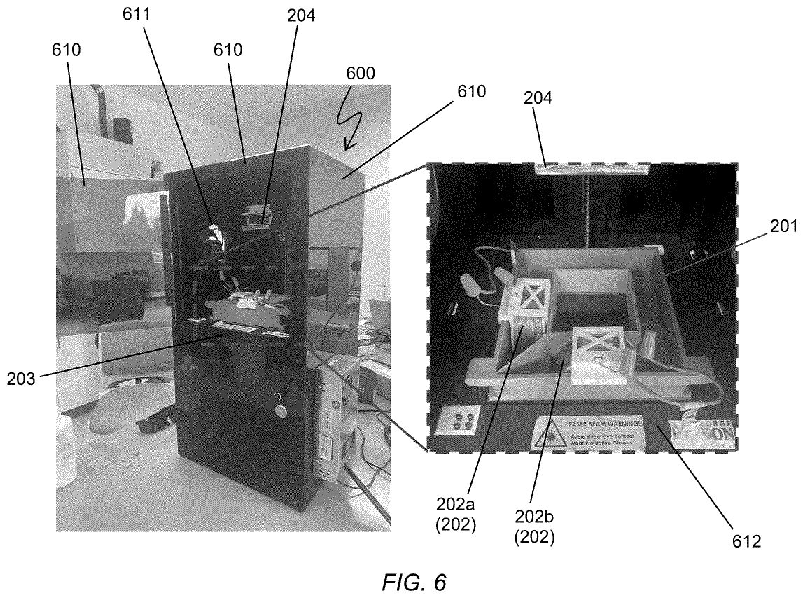

FIG. 6 is an exemplary AM apparatus 600 which includes printer panels 610 which enclose the printing operation to shield a user from UV exposure and to shield the printer from external disturbances. AM apparatus 600 further comprises a vat 201, a filler alignment system 202 that includes electromagnets 202a and 202b, a laser or LED(s) within housing 203, and a build plate 204.

Printer panels 610 may include one or more fan holes 611 to enhance ventilation within the printer configuration. Recognizing the significance of adequate airflow and temperature control during printing, this aspect can improve efficiency of the printing environment operation. Panels 610 may further include one or more holes facilitating accessibility for maintenance and repairs.

Bedplate 612 which supports the vat 201 includes access holes to accommodate the wires powering the solenoids 202a and 202b. For the illustrative embodiment of FIG. 6, there are two access holes, one at top right and one at bottom left of the bedplate 612. Access holes may be located in other areas to coincide with the wires when the solenoids are in different locations. This design element facilitated easy access for wiring maintenance or repairs, ensuring swift and efficient procedures.

Some embodiments may further include lighting which is not used for curing purposes. For example, an LED configuration may be integrated into the bedplate, offering advantages such as improved visibility and accuracy during the printing process. The LED configuration may be located in or around the printer's circuitry and/or in any area in the device to accommodate for space, aesthetics, or location such as but not limited to in one corner of the bedplate. The wiring for the LED configuration may be integrated into the printer's circuitry, ensuring seamless integration without causing interference with other components.

### Example

This Example demonstrates an SLA printing process that employs electromagnets to precisely adjust filler orientation. The SLA apparatus used for this Example matched apparatus 600 of FIG. 6.

The materials used in this Example included Hard Tough Resin, sourced from eSUN™ and cobalt powder, obtained from Sigma-Aldrich®. Computer-aided design (CAD) models were created using Autodesk Fusion 360 (v.2.0.19941). The models were sliced using Ultimaker Cura (v.5.7.2). All samples were fabricated using a Peopoly MOAI 200 SLA 3D printer, ensuring high precision and repeatability.

Cobalt particles of 300 mesh size were selected as the filler due to its magnetic properties which allow precise control of the orientation of the filler during the printing process. The cobalt was mixed with the resin using an electric mixer for 15 minutes at a speed of 500 rpm to ensure a uniform suspension of the filler in the matrix. The mixture was then transferred to a modified resin vat with a PMDA bottom. The vat was designed to accommodate the two electromagnets, as depicted in FIGS. 2A and 2B. The electromagnets field strength was set using a python script to control the orientation during printing. The script was written and executed in the Thonny (14.1.4) python IDE.

Samples were printed as Type V dog bone, in accordance with ASTM D638-14 standards for tensile testing. The printer settings used are in Table 1.

TABLE 1
SLA Printing Parameters

| Printing Parameters | Values | |
|---|---|---|
| Layer Height | 0.1 | mm |
| Speed | 280 | mm/sec |
| Laser Power | 61 | |
| Laser Wavelength | 405 | nm |

After printing was finished, the samples were washed in an isopropyl alcohol (IPA) bath for two minutes and then cured under an ultraviolet (UV) light for five minutes. The IPA bath/UV set up was the Elegoo Mercury Plus. This ensures that excess liquid resin is removed, and that the sample is fully cured. After curing the samples were carefully removed from the build plate. Then the remaining supports were removed, and the sample was manually sanded for a smooth finish and to minimize surface defects.

The orientation and distribution of cobalt fillers within the fabricated samples were analyzed using a Tomlov Digital Microscope. Images were captured to document filler alignment for each sample type: control, random orientation, 0-degree, and 90-degree orientations. The microscopy setup allowed clear visualization of filler alignment, providing qualitative evidence of the effectiveness of the electromagnetic orientation process.

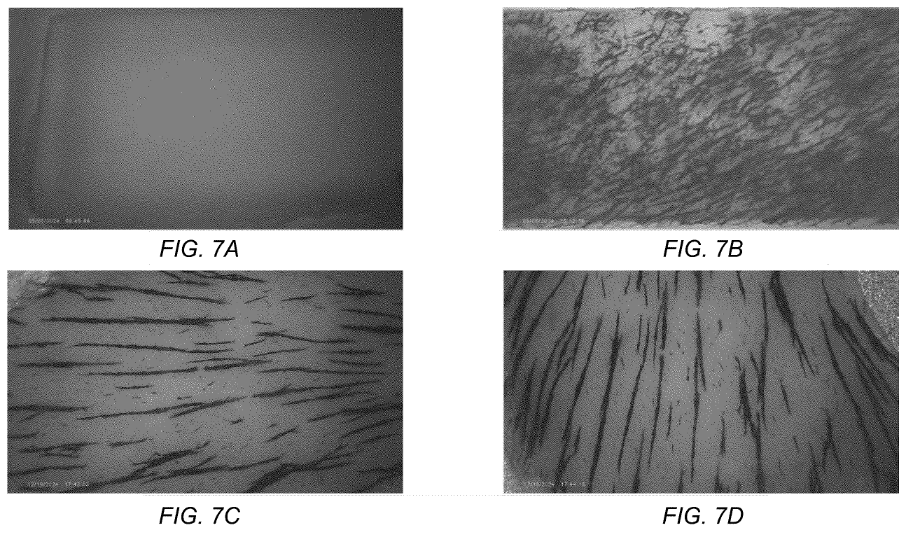

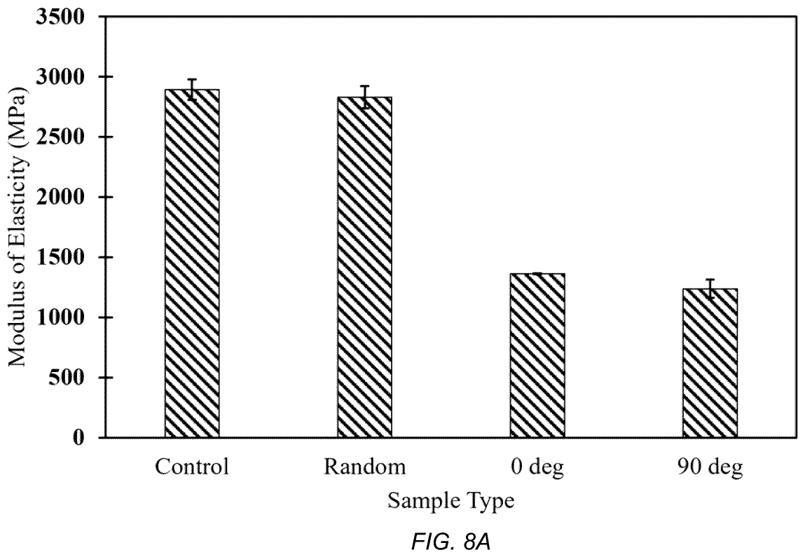

FIGS. 7A-7D are optical microscopy images capturing the distribution and orientation of cobalt fillers within the SLA-printed samples. In the control samples (FIG. 7A), no fillers were observed as expected. For the random orientation samples (FIG. 7B), the fillers were dispersed heterogeneously throughout the matrix without any preferential alignment. In the 0-degree orientation samples (FIG. 7C), the fillers were observed to align predominantly along the horizontal axis, while in the 90-degree orientation samples (FIG. 7D), a vertical alignment of the fillers was apparent. These observations confirm the effectiveness of the electromagnetic setup in directing the filler orientation during the printing process.

Tensile tests were performed with a 200 Series Electromechanical Universal Test Machine (UTM) from Test Resources Inc. (Shakopee, Minnesota, USA) equipped with an extensometer and controlled by Newton Universal software. The maximum load capacity is 5 kN and the lowest measurable load is 50 N. A constant deformation rate of 5 mm/min was applied to the dog bone sample. The loading conditions and sample creation were in compliance with ASTM D638-14. Two dog bone samples were prepared for each of the 4 sample types. The sample dimensions were measured, and they were loaded into the tensile testing machine. Then, the extensometer was applied. From the generated stress strain curve, we derived modulus of elasticity, yield strength and ultimate tensile strength.

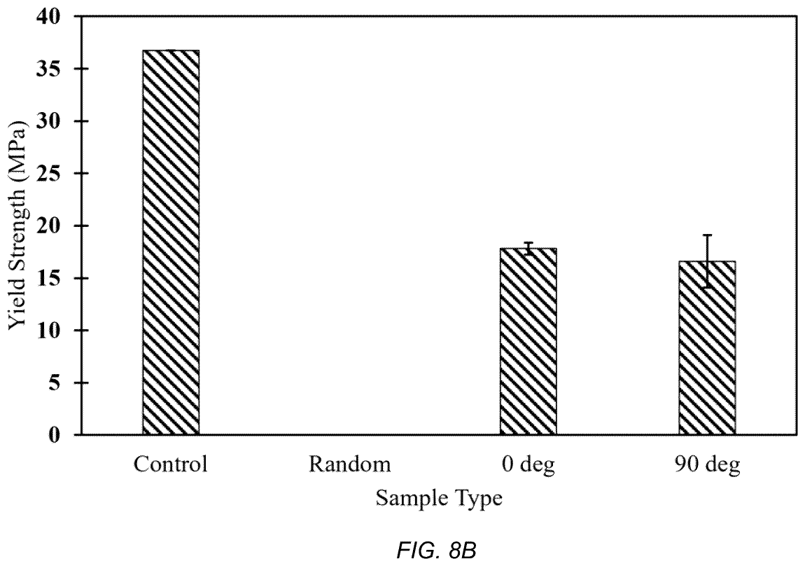

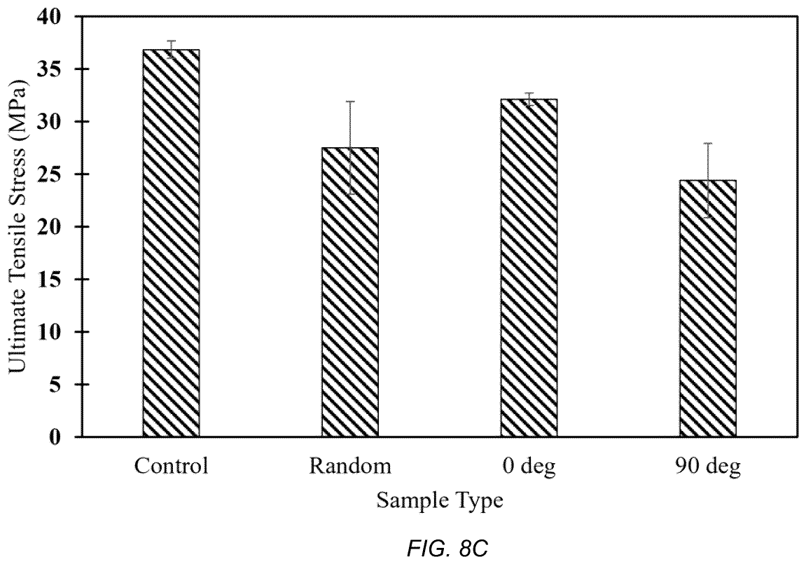

The mechanical properties of the SLA-printed dogbone samples, measured through tensile testing, are summarized in Table 2 and plotted in FIGS. 8A-8C. The results are categorized by sample type: control (no fillers), random orientation, 0-degree (horizontal alignment), and 90-degree (vertical alignment).

TABLE 2
Mechanical properties from Tensile Tests

| | | Ultimate | Modulus of |
|---|---|---|---|
| Sample | Yield Stress | Tensile | Elasticity |
| Type | (MPa) | Stress (MPa) | (MPa) |
| Control | 36.76 | 36.94 ± 0.82 | 2893.56 ± 85.72 |
| Random | 0 | 27.51 ± 4.41 | 2827.80 ± 92.55 |
| 0 degree | 17.81 ± 0.58 | 32.14 ± 0.58 | 1361.28 ± 3.93 |
| 90 degree | 16.59 ± 2.50 | 24.40 ± 3.54 | 1237.34 ± 76.64 |

The control samples exhibited the highest elastic modulus, averaging 2893.56±85.72 MPa. The random orientation samples had a slightly reduced modulus of 2827.80±92.55 MPa. In contrast, the 0-degree and 90-degree orientation samples demonstrated significantly lower moduli of 1361.28±3.93 MPa and 1237.34±76.64 MPa, respectively. This reduction in stiffness can be attributed to the alignment of fillers, which disrupts the isotropic properties of the polymer matrix.

The control samples also displayed the highest yield strength at 36.76±0 MPa. The random orientation samples exhibited brittle failure with no clear yield point. The 0-degree samples showed a yield strength of 17.81±0.58 MPa, while the 90-degree samples recorded a yield strength of 16.59±2.49 MPa. These results suggest that the filler orientation significantly influences the onset of plastic deformation.

The control samples recorded the highest UTS at 36.84±0.81 MPa. The random orientation samples had a reduced UTS of 27.51±4.40 MPa. Interestingly, the 0-degree samples demonstrated a UTS of 32.13±0.58 MPa, which is higher than the 90-degree samples, which had a UTS of 24.39±3.53 MPa. This trend aligns with the anisotropic reinforcement effect introduced by the cobalt fillers.

The tensile testing results revealed significant variations in mechanical properties across the different sample types, highlighting the influence of filler orientation on material performance. The control samples, devoid of fillers, exhibited the highest elastic modulus, yield strength, and ultimate tensile strength (UTS), underscoring the superior isotropic mechanical properties of the unmodified polymer matrix. The inclusion of cobalt fillers introduced anisotropic behavior, with the 0-degree (horizontal) samples showing higher UTS compared to the 90-degree (vertical) samples. This can be attributed to the alignment of fillers along the tensile load direction in the 0-degree samples, which facilitated better stress transfer and enhanced mechanical performance. Conversely, the 90-degree alignment resulted in lower mechanical properties as the tensile load was perpendicular to the filler orientation, limiting their reinforcing effect. This finding demonstrates that the directional alignment of magnetic fillers plays a critical role in tailoring the mechanical properties of composites.

Interestingly, the random orientation samples showed a reduction in UTS and brittle failure behavior compared to the control. This outcome is likely due to uneven stress distribution caused by a heterogeneous dispersion of fillers, which can create stress concentrations and weaken the composite material.

While the filler alignment improved directional mechanical properties, the overall reduction in elastic modulus and yield strength for the 0-degree and 90-degree samples compared to the control suggests that the presence of fillers disrupted the continuity of the polymer matrix. Furthermore, the use of 1% cobalt fillers may have influenced the photopolymerization process, as suggested in literature, where higher filler content can compete with the photo initiator for light absorption, potentially leading to incomplete curing and compromised material properties.

This Example demonstrate the potential of electromagnetic alignment to tailor the mechanical properties of SLA-printed composites. By controlling filler orientation, it is possible to design materials with specific anisotropic characteristics, enabling customized solutions for applications requiring directional strength. This Example underscores the importance of aligning fillers strategically to exploit their reinforcing potential while maintaining the integrity of the polymer matrix.

The results of this Example demonstrate the potential of using electromagnetic fields to align cobalt during SLA printing to tune mechanical properties. Tensile testing showed that the filler orientation can radically affect material performance. Specifically, the elastic modulus was significantly influenced by the alignment of fillers. The 0-degree samples exhibited a higher elastic modulus due to the alignment of fillers perpendicular to the tensile load direction. Conversely, the 90-degree samples demonstrated a reduction in elastic modulus, as the filler alignment was along the tensile load direction, limiting its reinforcing effect. Additionally, the overall reduction in elastic modulus compared to the control samples indicates the need for optimization in filler content and photopolymerization conditions.

Some embodiments of the present invention may be a system, a device, a method, and/or a computer program product. A system, device, or computer program product may include a computer readable storage medium (or media) having computer readable program instructions thereon for causing a processor to carry out aspects of the present invention, e.g., processes or parts of processes or a combination of processes described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Processes described herein, or steps thereof, may be embodied in computer readable program instructions which may be paired with or downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Python, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions and in various combinations.

These computer readable program instructions may be provided to one or more processors of one or more general purpose computers, special purpose computers, or other programmable data processing apparatuses to produce a machine or system, such that the instructions, which execute via the processor(s) of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Where a range of values is provided in this disclosure, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be separated from or combined with the features of any of the other several embodiments without departing from the scope or spirit of the present invention. Any recited method can be carried out in the order of steps recited or in any other order which is logically possible. Alternative methods may combine different elements of specific detailed methods described above and in the figures.

While exemplary embodiments of the present invention have been disclosed herein, one skilled in the art will recognize that various changes and modifications may be made without departing from the scope of the invention as defined by the appended claims.

What is claimed is:

1. A method of additive manufacturing, comprising
combining in a vat at least one liquid resin and one or more fillers, wherein at least one filler of the one or more fillers is magnetically orientable;
manipulating orientation of the at least one filler with a magnetic field; and
rastering a UV light beam across a print area, wherein the UV laser beam cures the at least one liquid resin as a matrix that holds the at least one filler in the orientation caused by the magnetic field.

2. The method of claim 1, further comprising repeating the manipulating and rastering steps for multiple successive layers with layer-by-layer customization of filler orientation.

3. The method of claim 1, wherein the at least one filler comprises metal fibers.

4. The method of claim 1, wherein the at least one filler comprises cobalt.

5. The method of claim 1, wherein the at least one filler comprises non-metallic fibers coated with at least one metal.

6. The method of claim 1, further comprising sputtering metal onto non-metallic fibers, wherein the non-metallic fibers sputtered with metal are used as the at least one filler.

7. The method of claim 1, further comprising changing an orientation of the magnetic field.

8. The method of claim 7, wherein the orientation of the magnetic field is changed while rastering the UV light beam.

9. The method of claim 7, wherein changing the orientation of the magnetic field comprises deactivating one or more electromagnets and/or activating one or more further electromagnets.

10. The method of claim 7, wherein changing the orientation of the magnetic field comprises moving one or more magnets relative to a build plate to which the matrix is attached and/or moving the build plate relative to one or more magnets supplying the magnetic field.

11. The method of claim 7, wherein changing the orientation of the magnetic field comprises moving one or more magnets relative to a build plate to which the matrix is attached.

12. The method of claim 1, wherein the manipulating is performed with at least two magnets positioned at opposite sides of the vat.

13. A composite, produced by the method of claim 1.

14. An additive manufacturing (AM) apparatus, comprising
a vat for holding a combination of at least one liquid resin and one or more fillers, wherein at least one filler of the one or more fillers is magnetically orientable;
a filler alignment system configured for manipulating orientation of the at least one filler with a magnetic field;
a laser or LED configured to emit a UV light beam with at least one designated wavelength suited for curing the at least one liquid resin, wherein the UV light beam is rasterable across a print area, wherein the UV light beam cures the at least one liquid resin as a matrix that holds the at least one filler in the orientation caused by the magnetic field; and
a build plate to which the matrix is attached.

15. The AM apparatus of claim 14, wherein the filler alignment system is configured to change an orientation of the magnetic field.

16. The AM apparatus of claim 15, wherein the filler alignment system is configured to change the orientation of the magnetic field while the AM apparatus is rastering the UV light beam.

17. The AM apparatus of claim 15, wherein the filler alignment system comprises a plurality of electromagnets, wherein the filler alignment system is configured to change the orientation of the magnetic field by deactivating one or more of the plurality of electromagnets and/or activating one or more of the plurality of electromagnets.

18. The AM apparatus of claim 15, wherein the filler alignment system is configured to change the orientation of the magnetic field by moving one or more magnets relative to the build plate and/or moving the build plate relative to one or more magnets supplying the magnetic field.

19. The AM apparatus of claim 15, wherein the filler alignment system is configured to change the orientation of the magnetic field by moving one or more magnets relative to the build plate.

20. The AM apparatus of claim 14, wherein the filler alignment system comprises at least two magnets positioned at opposite sides of the vat.
